(19) United States
(12) Patent Application Publication
(10) Pub. No.: US 2026/0030282 A1
(43) Pub. Date: Jan. 29, 2026

(54) METHOD, DEVICE AND STORAGE MEDIUM APPARATUS FOR PRESENTING QUERY RESULTS

(71) Applicant: Beijing Zitiao Network Technology Co., Ltd., Beijing (CN)

(72) Inventors: Peipei Wu, Beijing (CN); Songyu Wang, Beijing (CN); Weiwei Xue, Beijing (CN); Ye Lin, Beijing (CN)

(21) Appl. No.: 19/279,917

(22) Filed: Jul. 24, 2025

(30) Foreign Application Priority Data
Jul. 24, 2024 (WO) PCT/CN2024/107401

(51) Int. Cl. G06F 16/34; G06F 3/0481; G06F 16/332

(52) U.S. Cl. CPC G06F 16/345; G06F 3/0481; G06F 16/332

(57) ABSTRACT

According to embodiments of the disclosure, there is provided a method, an apparatus, a device and a computer-readable storage medium for presenting a query result. The method includes: in response to receiving a query request, acquiring a query intention associated with the query request; determining, from a plurality of result presentation templates, a result presentation template that matches the query intention; and presenting, based on the result presentation template, a query result page for the query request, the query result page including a first result area corresponding to the result presentation template, wherein the first result area is configured to provide a recommended first query result from a group of query results for the query request. Therefore, a clearer, more harmonious and visually hierarchical query result page can be provided for a user for the query request of the user.

### CROSS-REFERENCE

This application claims the benefit of International Patent Application No. PCT/CN2024/107401 filed on Jul. 24, 2024, entitled “METHOD, APPARATUS, DEVICE, AND STORAGE MEDIUM FOR PRESENTING QUERY RESULTS”, which is hereby incorporated by reference in its entirety.

### FIELD

Exemplary implementations of the present disclosure generally relate to the field of computers, and in particular to a method, an apparatus, a device and a computer-readable storage medium for presenting a query result.

### BACKGROUND

With the rapid development of Internet, more and more applications are designed to provide users with various services. For example, an application may provide a user with a query service, and an application may acquire a query request from the user (for example, a query text, i.e., a “question”, entered by the user) and provide, based on the query request, a query result corresponding to the question. Therefore, a visual hierarchy is expected on a page that presents the query result.

### SUMMARY

In a first aspect of the present disclosure, there is provided a method for presenting a query request. The method includes: in response to receiving a query request, acquiring a query intention associated with the query request; determining, from a plurality of result presentation templates, a result presentation template that matches the query intention; and presenting, based on the result presentation template, a query result page for the query request, the query result page including a first result area corresponding to the result presentation template, the first result area being configured to provide a recommended first query result from a group of query results for the query request.

In a second aspect of the present disclosure, there is provided an apparatus for presenting a query request. The apparatus includes: an intention acquiring module configured to acquire, in response to receiving a query request, a query intention associated with the query request; a template determining module configured to determine, from a plurality of result presentation templates, a result presentation template that matches the query intention; and a page presenting module configured to present, based on the result presentation template, a query result page for the query request, the query result page including a first result area corresponding to the result presentation template, the first result area being configured to provide a recommended first query result from a group of query results for the query request.

In a third aspect of the present disclosure, there is provided an electronic device. The electronic device includes: at least one processing unit; and at least one memory coupled to the at least one processor and storing instructions executable by the at least one processor, the instructions, when executed by the at least one processor, causes the electronic device to perform the method according to the first aspect of the present disclosure.

In a fourth aspect of the present disclosure, there is provided a computer-readable storage medium including computer program stored thereon, the computer program, when executed by a processor, causes the processor to implement the method according to the first aspect of the present disclosure.

In a fifth aspect of the present disclosure, there is provided a computer program product. The program product, including a computer program, wherein the computer program, when executed by a processor, implements the method according to the first aspect of the present disclosure.

It would be appreciated that the content described in the Summary section is neither intended to define key or essential features of the embodiments of the present disclosure, nor is it intended to limit the scope of the present disclosure. Other features of the present disclosure will be readily understood through the following descriptions.

### BRIEF DESCRIPTION OF THE DRAWINGS

The above and other features, advantages and aspects of implementations of the present disclosure will become more apparent in combination with the accompanying drawings and with reference to the following detailed descriptions. In the accompanying drawings, the same or similar reference symbols refer to the same or similar elements, in which:

FIG. 1 shows a schematic diagram of an example environment in which the embodiments of the present disclosure can be implemented;

FIG. 2 shows a schematic diagram of a process for presenting a query result according to some embodiments of the present disclosure;

FIGS. 3A to 3C shows schematic diagrams of example interfaces for presenting query results according to some embodiments of the present disclosure;

FIGS. 4A to 4E shows schematic diagrams of example interfaces of different assemblies according to some embodiments of the present disclosure;

FIG. 5 shows a schematic diagram of an example interface of a question-and-answer result presentation template according to some embodiments of the present disclosure;

FIG. 6 shows a schematic diagram of an example interface of a content aggregation result presentation template according to some embodiments of the present disclosure;

FIG. 7A shows a schematic diagram of an example interface of an entity aggregation result presentation template according to some embodiments of the present disclosure;

FIG. 7B shows a schematic diagram of an example interface of result presentation templates of different entities according to some embodiments of the present disclosure;

FIG. 8 shows a schematic structural block diagram of an apparatus for presenting a query result according to some embodiments of the present disclosure; and

FIG. 9 shows a block diagram of an electronic device in which one or more embodiments of the present disclosure can be implemented.

### DETAILED DESCRIPTION

The following describes embodiments of the present disclosure in more detail with reference to the accompanying drawings. Although some embodiments of the present disclosure are shown in the accompanying drawings, it should be understood that the present disclosure may be implemented in various forms, and should not be construed as being limited to the embodiments described herein. On the contrary, these embodiments are provided for more thorough and complete understanding of the present disclosure. It should be understood that the accompanying drawings and embodiments of the present disclosure are merely used for illustration, but are not intended to limit the protection scope of the present disclosure.

In descriptions of embodiments of the present disclosure, the term “include” and similar terms thereof should be understood as open inclusion, that is, “include but is not limited to”. The term “based on” should be understood as “at least partially based on”. The terms “one embodiment” or “the embodiment” should be understood as “at least one embodiment”. The term “some embodiments” should be understood as “at least some embodiments”. Other explicit and implicit definitions may also be included below.

In this specification, unless explicitly stated, performing a step “in response to A” does not mean that the step is performed immediately after “A”, but may include one or more intermediate steps.

It can be understood that data involved in this technical solution (including, but not limited to, the data itself, the acquisition or use of the data) shall comply with the requirements of the corresponding laws and regulations and relevant provisions.

It can be understood that before using the technical solutions disclosed in the embodiments of the present disclosure, a user should be informed of the type, the scope of use, the use scenario, and the like of personal information involved in the present disclosure in accordance with the relevant laws and regulations in an appropriate fashion, and the user's authorization should be obtained.

For example, in response to receiving an active request from the user, prompt information is sent to the user to expressly prompt the user that an operation that the user requests to perform needs to obtain and use personal information of the user, to allow the user to choose, according to the prompt information, whether to provide the personal information to software or hardware such as an electronic device, an application, a server or a storage medium that performs the operations in the technical solutions of the present disclosure.

As an optional but non-limiting implementation, in response to receiving the active request from the user, a fashion of sending the prompt information to the user may be, for example, a fashion of a pop-up window in which the prompt information may be presented in a text fashion. In addition, the pop-up window may further carry selection controls for the user to choose “agree” or “disagree” to provide the personal information to the electronic device.

It can be understood that the above processes of giving a notification and obtaining user's authorization are only illustrative and do not constitute a limitation on the implementations of the present disclosure, and other fashions complying with the relevant laws and regulations may be applied in the implementations of the present disclosure.

### Example Environment

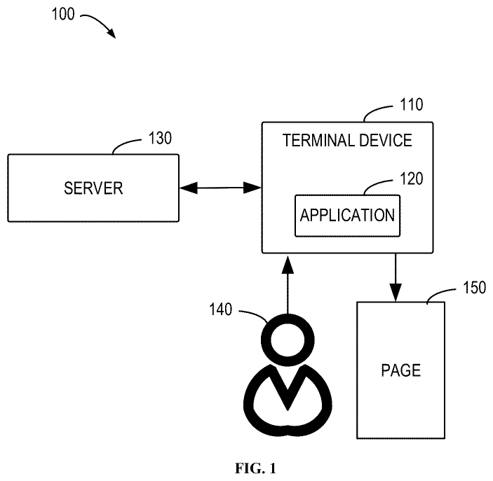

FIG. 1 shows a schematic diagram of an example environment 100 in which the embodiments of the present disclosure can be implemented. In the example environment 100, an application 120 is installed in a terminal device 110. A user 140 may interact with the application 120 via the terminal device 110 and/or an attachment device of the terminal device 110.

In some embodiments, the application 120 may be any suitable application capable of providing a query service. In the environment 100 of FIG. 1, the terminal device 110 may present a page 150 of the application 120 if the application 120 is in an active state. The page 150 may include various pages that can be provided by the application 120, such as a query page, a search page and a search result presentation page.

In some embodiments, the terminal device 110 communicates with a server 130 to implement the supply of a service for the application 120. The terminal device 110 may be a mobile terminal, a fixed terminal or a portable terminal of any type, which includes a mobile phone, a desktop computer, a laptop computer, a notebook computer, a netbook computer, a tablet computer, a media computer, a multimedia tablet computer, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the above items, and includes accessories and peripherals for these devices or any combination thereof. In some embodiments, the terminal device 110 may also support a user-specific interface (e.g., a “wearable” circuit) of any type. The server 130 may be various types of computing systems/servers capable of providing computing power, including but not limited to a mainframe, an edge computing node, a computing device in a cloud environment, etc.

It should be understood that the structures and the functions of various elements in the environment 100 are described for illustrative purposes only and do not imply any limitation on the scope of the present disclosure.

### Example Process

Traditionally, a presentation mode of a query result page may be designed by following design specifications such as the principles of readability, accuracy and system operation rationality. However, such an approach requires that different types of result pages separately involve their respective presentation modes, which requires a lot of communication between a developer of a query system and a designer of a page effect and hence leads to a complex workflow. Further, since a plurality of query results are presented in sequence, a user needs to traverse all the query results one by one to find a desired result.

In view of this, according to embodiments of the present disclosure, a method for presenting a query request is provided. The method includes: if a query request is received, acquiring a query intention associated with the query request; determining, from a plurality of result presentation templates, a result presentation template that matches the query intention; and presenting, based on the result presentation template, a query result page for the query request, the query result page including a first result area corresponding to the result presentation template, and the first result area being configured to provide a recommended first query result from a group of query results for the query request. Therefore, a clearer, more harmonious and visually hierarchical query result page can be provided to a user for the query request of the user. Further, the presentation template may provide a uniform layout and a uniform result presentation framework, such that the query results corresponding to different query intentions can be presented uniformly.

Some example embodiments of the present disclosure will be described below with continued reference to the accompanying drawings. It should be understood that pages illustrated in the accompanying drawings are merely examples, and various page designs may actually be present. Individual graphic elements in the pages may have different layouts and different visual representations, one or more of the elements may be omitted or replaced, and one or more other elements may be present additionally, which will not be limited in the embodiments of the present disclosure in this respect. In addition, the example embodiments will be described hereinafter mainly with respect to the terminal device 110. It should be understood that actions described with respect to the terminal device 110 may be performed by the application on the terminal device 110, or may be performed by the application in cooperation with its server side (e.g., a server).

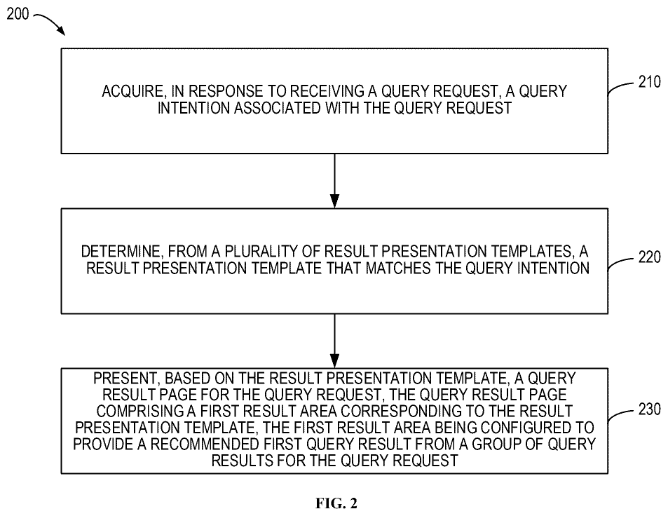

A flowchart of a process for presenting a query result according to the present disclosure will be described below with reference to FIG. 2. FIG. 2 shows a schematic diagram of a process 200 for presenting a query result according to some embodiments of the present disclosure. The process 200 may be implemented at the terminal device 110. The process 200 will be described below with reference to FIG. 1.

At block 210, the terminal device 110 acquires, in response to receiving a query request, a query intention associated with the query request. In some embodiments, the terminal device 110 may receive a query request from a user (e.g., a user 140). The terminal device 110 may receive the query request from the user in any appropriate manner, which is not limited in the present disclosure. For example, the terminal device 110 may provide an input box and receive the query request from the user via the input box. The query request may be of any appropriate type, including, but not limited to, a text, a voice, a video, an image, etc.

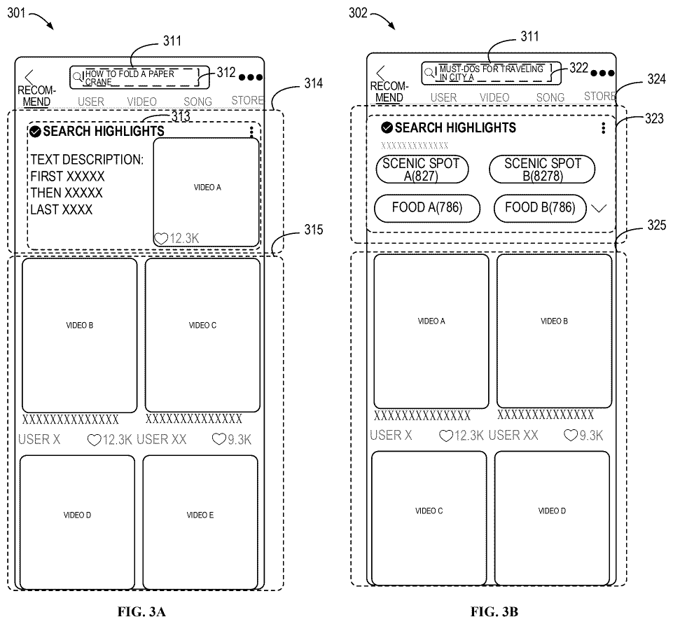

If receiving the query request, the terminal device 110 acquires the query intention associated with the query request. In some examples, the query request may be a request of an appropriate category, such as a query request of a question-and-answer category, a query request of a content search category and a query request of an entity search category. The query intention may be determined using a pre-trained machine learning model, and alternatively and/or additionally, the query intention may be determined based on semantic analysis for the query request. FIGS. 3A to 3C show schematic diagrams of example interfaces 301 to 303 for presenting query results according to some embodiments of the present disclosure.

Referring to an example interface 301 as shown in FIG. 3A, if the terminal device 110 receives a query request 312 of a question-and-answer category (e.g., how to fold a paper crane) based on an input box 311, it acquires a query intention associated with the query request 312. Referring to an example interface 302 as shown in FIG. 3B, if the terminal device 110 receives a query request 322 of a content search category (e.g., must-dos for traveling in city A or hot news) based on the input box 311, it acquires a query intention associated with the query request 322. Referring to an example interface 303 as shown in FIG. 3C, if the terminal device 110 receives a query request 332 of an entity search category (such as a song A, a singer XX, a location L, a movie M and a game G) based on the input box 311, it acquires a query intention associated with the query request 332.

At block 220, the terminal device 110 determines, from a plurality of result presentation templates, a result presentation template that matches the query intention. In some embodiments, the result presentation templates include, but are not limited to, a question-and-answer result presentation template, a content aggregation result presentation template, and an entity aggregation result presentation template. For example, a result presentation template corresponding to the query request of the question-and-answer category is the question-and-answer result presentation template, a result presentation template corresponding to the query request of the content search category is the content aggregation result presentation template, and a result presentation template corresponding to the query request of the entity search category is the entity aggregation result presentation template.

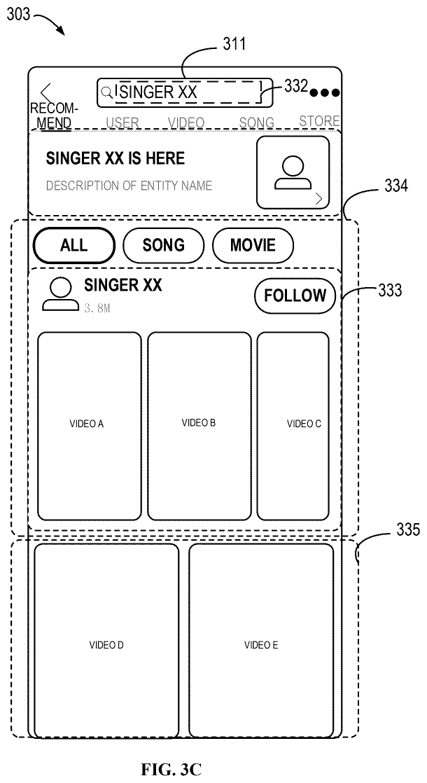

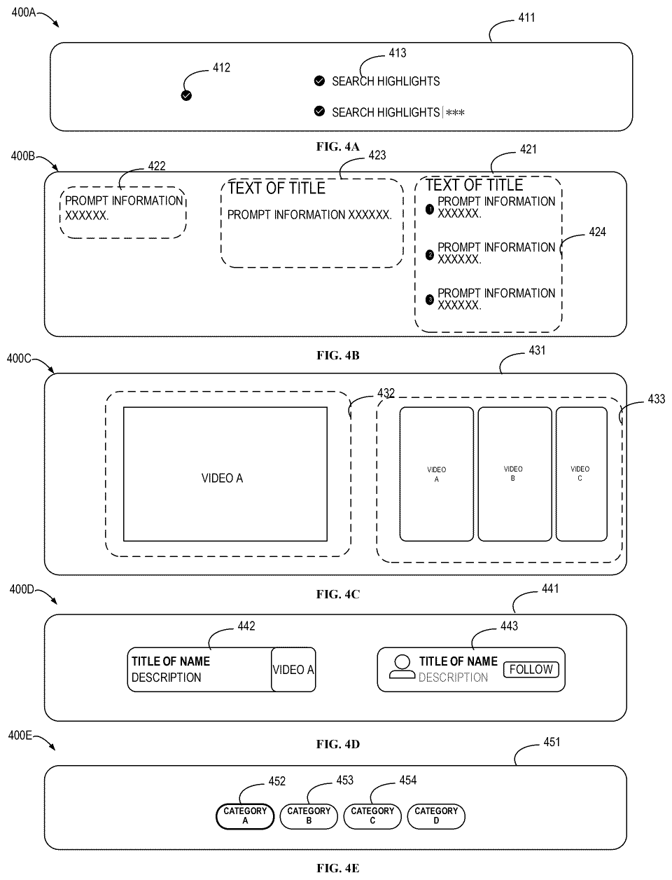

In some embodiments, the result presentation template includes a group of assemblies selected according to the query intention. It can be understood that the terminal device 110 selects, according to the acquired query intention, a group of assemblies to generate a result presentation template. The determination of the result presentation template by the terminal device 110 will be described below with reference to FIGS. 4A to 4E and FIGS. 5 to 7B. FIGS. 4A to 4E show schematic diagrams of example interfaces 400A to 400E of different assemblies according to some embodiments of the present disclosure. FIGS. 5 to 7B show schematic diagrams of example interfaces 500 to 700B of different result presentation templates according to some embodiments of the present disclosure.

In some embodiments, the group of assemblies include a title assembly for specifying a title of the result presentation template. The group of assemblies further include a content assembly for specifying content of the result presentation template. The content of the result presentation template includes at least one of a text, an image, an audio and a video. Referring to an example interface 400A as shown in FIG. 4A, a title assembly 411 (sometimes referred to as a “tag assembly”) for specifying the title of the result presentation template may include a visual style 412 and/or descriptive information 413. In some embodiments, the visual style 412 and/or the descriptive information 413 may be adjusted, and FIG. 4A is merely exemplary, which will not be limited in the present disclosure.

Referring to an example interface 400B as shown in FIG. 4B, a content assembly 421 (sometimes referred to as a “text assembly”) for specifying a text of the result presentation template may be presented in a “single text description” style 422. The content assembly 421 may also be presented in a “text description+title” style 423. Alternatively, the content assembly 421 may also be presented in a “text entry description+title” style 424.

Referring to an example interface 400C as shown in FIG. 4C, a content assembly 431 (sometimes referred to as a “video assembly”) for specifying a video of the result presentation template may be presented in a “single video” style 432. The content assembly 431 may also be presented in a “multi-video” style 433. In some examples, if the content assembly 431 is presented in the “multi-video” style 433, the user may swipe left and right and/or up and down to view the video among the multiple videos.

In some embodiments, the group of assemblies may further include a user assembly for specifying information of a user in the result presentation template. The user is a user in an application for executing the method for presenting the query result. It can be understood that the information of the user in the result presentation template refers to information corresponding to the user contained in the query request. For example, if a user A initiates the query request of the entity search category (for example, a singer XX), the result presentation template includes the user assembly for indicating information of the singer XX.

Referring to an example interface 400D as shown in FIG. 4D, a user assembly 441 (sometimes referred to as a “head assembly”) is presented in a style 442. In some examples, the style 442 may include account information of the user and a video associated with the user. The user assembly 441 may also be presented in a style 443. In some examples, the style 443 may include account information of the user, a visual style of the user, etc.

In some embodiments, the group of assemblies may further include a categorization assembly for specifying a categorization tag in the result presentation template. Referring to an example interface 400E as shown in FIG. 4E, the categorization assembly 451 may include a category A 452, a category B 453, a category C 454, etc. In some embodiments, the categorization tag may be determined by a user, a publisher, or a system.

Therefore, through assembly-based establishment of modules, a design team can improve the universality and the design efficiency of the modules. Furthermore, the development time can be shortened, and the consistency of various interface elements can be ensured. The generation of the result presentation template based on different assemblies will be described below with reference to FIGS. 5 to 7B.

In some embodiments, the terminal device 110 selects, according to the acquired query intention, from a plurality of result presentation templates, a result presentation template matching the query intention and including a group of assemblies. It can be understood that by performing assembly integration on design elements such as texts, videos and pictures for use in different answer results, a modular approach may be adopted for building and reusing. Therefore, the stability and the predictability of the visual effect of a result search module can also be improved.

Referring to an example interface 500 as shown in FIG. 5, the terminal device 110 may determine, according to the query intention, a result presentation template 510 of a single video for the query request of the question-and-answer category. The result presentation template 510 of the single video includes a title assembly 411 and a content assembly 412. In some examples, the content assembly 412 includes a text assembly 511 and a video assembly 512. The terminal device 110 may present the title assembly 411 in a title highlighting style, for example, highlighting “search highlights”. By enhancing the prominence of symbols, authoritative selection of answers can be highlighted, thereby reinforcing the perception that the recommended query result (for example, displayed in a “home page card” generated using the template) is a quality answer.

The terminal device 110 may also determine, according to the query intention, a result presentation template 520 of a single video in a vertical layout for the query request of the question-and-answer category. The result presentation template 520 of the single video in the vertical layout includes the title assembly 411 and the content assembly 412. In some examples, the content assembly 412 further includes a text assembly 521 and a video assembly 522, and the result presentation template 520 is presented in a vertical-layout format.

The terminal device 110 may also determine, according to the query intention, a result presentation template 530 of a single text for the query request of the question-and-answer category. The result presentation template 530 of the single text includes the title assembly 411 and the content assembly 412 (e.g., single text). The terminal device 110 may also determine, according to the query intention, a result presentation template 540 of a single text entry for the query request of the question-and-answer category. The result presentation template 540 of the single text entry includes the title assembly 411 and the content assembly 412 (e.g., single text entry).

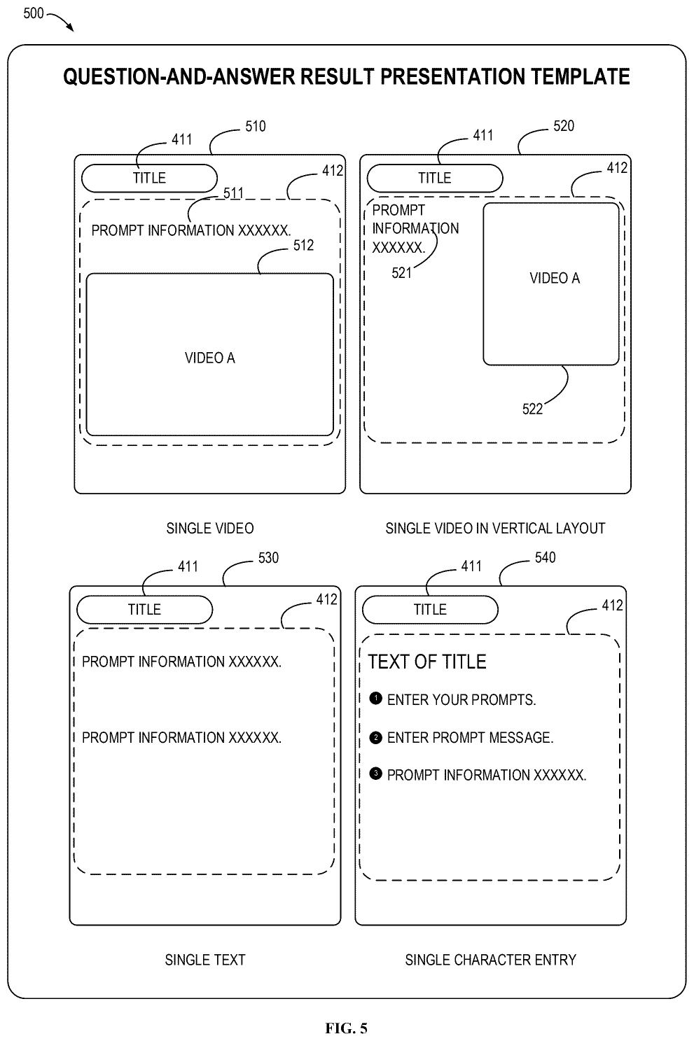

Referring to an example interface 600 as shown in FIG. 6, the terminal device 110 may determine, according to the query intention, a result presentation template 610 of an aggregated video for the query request of the content search category. The result presentation template 610 of the aggregated video includes the title assembly 411 and the content assembly 412. The content assembly 412 may include a text assembly 611 and a multi-video assembly 612. The terminal device 110 may also determine, according to the query intention, the result presentation template 620 of a text-free aggregated video for the query request of the content search category. The result presentation template 620 of the text-free aggregated video includes the title assembly 411 and the content assembly 412. The content assembly 412 may include a multi-video assembly 622.

For the query request of the content search category, the terminal device 110 may determine, according to the query intention, a result presentation template 630 of an aggregated viewpoint including statistical data. The result presentation template 630 of the aggregated viewpoint includes the title assembly 411, the content assembly 412 and a categorization assembly 413. The content assembly 412 may include the text assembly. The categorization assembly 413 may include a category A, a category B, a category C, etc., where the category A, the category B, the category C, etc. include statistical data of corresponding search results respectively (for example, 123 query results related to the category A are found). For the query request of the content search category, the terminal device 110 may also determine, according to the query intention, a result presentation template 640 of an aggregated video not including statistical data. The result presentation template 640 of the aggregated video not including statistical data includes the title assembly 411, the content assembly 412 and the categorization assembly 413. The content assembly 412 may include the text assembly. The categorization assembly 413 may include a category A, a category B, a category C, etc.

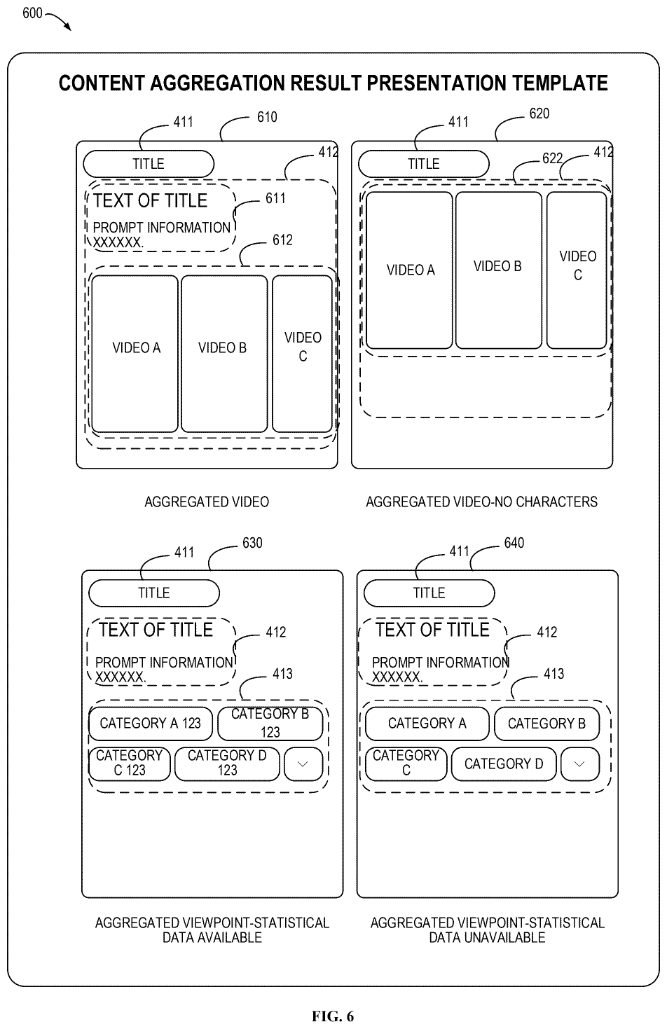

Referring to an example interface 700A as shown in FIG. 7A, for the query request of the entity search category, the terminal device 110 may determine, according to the query intention, a result presentation template 710 having a platform account. The result presentation template 710 having the platform account includes the title assembly 411 (sometimes also referred to as a subject head), the content assembly 412, the categorization assembly 413, and a user assembly 414. The content assembly 412 may include a video A, a video B, etc.

For the query request of the entity search category, the terminal device 110 may determine, according to the query intention, a result presentation template 720 having no platform account. The result presentation template 720 having no platform account includes the title assembly 411, the content assembly 412, and the categorization assembly 413. The content assembly 412 may include a video A, a video B, etc.

In some embodiments, the layout of the title assembly 411 (sometimes also referred to as a subject head) may also be adjusted. Referring to an example interface 700B as shown in FIG. 7B, if the query request is about a user A, a subject head 730 may include basic information 731 of the user A and a visual style 732 of the user A. If the query request is about a location A, the subject head 740 may include a picture 741 of the location A and a corresponding control 742 for viewing detailed introduction of the location A. If the query request is about music A, the subject head 750 may include basic information 751 of the music A and a visual style 752 of the music A. If the query request is about a movie/game A, the subject head 760 may include a picture 761 of the movie/game A and a corresponding control 762 for viewing detailed resources of the movie/game A.

In the present disclosure, search results may be abstracted into several general layouts by category, such as a question-and-answer result presentation template layout for finding resources and answers, a content aggregation template layout corresponding to the content search category, and an entity aggregation template layout corresponding to the entity search category. In this way, the user can be provided with a clearer, more harmonious, and visually hierarchical query result page.

In some embodiments, the target assembly in the group of assemblies includes a plurality of configuration parameters. In some embodiments, the plurality of configuration parameters include at least one of: a dimension parameter for setting a dimension of the target assembly; a location parameter for setting a location of the target assembly; and a content parameter for setting content of the target assembly. In some embodiments, the plurality of configuration parameters are interfaces between a search engine and a query result page, for transmitting the parameters.

In some examples, any assembly in the group of assemblies may include a dimension parameter for setting a dimension, a location parameter for setting a location, and a content parameter for setting content. The dimension, the location and the content of any assembly in the group of assemblies in the result presentation template are determined by the dimension parameter, the location parameter and the content parameter respectively.

In some embodiments, the terminal device 110 may also set at least one of the dimension parameter and the location parameter according to a predetermined layout rule. Then, the terminal device 110 sets the content parameter according to a first query result. In some examples, the dimension parameter and the location parameter may be default parameters, while the content parameter needs to be set in real time according to the query result.

In some embodiments, for the target assembly in the group of assemblies in the result presentation template, the terminal device 110 extracts data that matches the target assembly from the first query result. Then, the terminal device 110 sets the content parameter of the target assembly according to the data. In some examples, for the target assembly in the result presentation template, the terminal device 110 extracts data that matches the target assembly in real time. After that, the terminal device 110 sets the content parameter of the target assembly according to the extracted data.

In some embodiments, for the target assembly in the group of assemblies, a plurality of examples in a plurality of result presentation templates have the same visual attribute. The plurality of examples of the assemblies in the plurality of result presentation templates have the same visual attribute. In this way, the appearance consistency is achieved.

Continuing with the process 200, at block 230, the terminal device 110 presents, based on the result presentation template, a query result page for the query request. In some embodiments, the query result page includes a first result area (sometimes also referred to as a “first card”) corresponding to the result presentation template. Correspondingly, the first result area is configured to provide a recommended first query result from a group of query results for the query request.

In some embodiments, the terminal device 110 may acquire a query result corresponding to the query request by using a search engine. Subsequently, the terminal device 110 embeds the query result into the determined result presentation template, and in turn presents the query result page for the query request. In some embodiments, the terminal device 110 may determine a plurality of query results for the query request. Therefore, the terminal device 110 may provide, in the query result page, a result area for a recommended query result from the plurality of query results.

In some embodiments, a first matching degree between the first query result and the query request is higher than at least one second matching degree between at least one second query result from the group of query results and the query request. The terminal device 110 selects, from the plurality of query results, a query result that has a high matching degree with the query request, and presents the query result in the first result area in the query result page. In this way, the most relevant query result can be presented at a more prominent location.

In some embodiments, the query result page may further include a second result area, and the second result area is intended to present the at least one second query result from the group of query results. A location of the at least one second query result in the second result area is determined according to the matching degree between the first query result and the query request. It can be understood that the query result that has the highest matching degree with the query request is presented in the first result area of the query result page, and the query result that has the second highest matching degree with the query request is presented in the second result area of the query result page.

Referring to an example interface 301 as shown in FIG. 3A, if the terminal device 110 receives the query request 312 of the question-and-answer category (e.g., how to fold a paper crane) based on the input box 311, it determines the result presentation template that matches the query intention associated with the query request 312. Then, the terminal device 110 embeds the query result corresponding to the query request 312 into the result presentation template to form the result query page. The result query page includes a result area 314 for providing a recommended query result 313 from the plurality of query results.

In some examples, the terminal device 110 may also display the corresponding query result 313 in a title highlighting style. For example, the content corresponding to “Search Highlights” is the recommended query result 313, i.e., the query result 313 that has the highest matching degree with the query request 312. Next, the terminal device 110 presents, in the result area 315 of the query result page, the query result with the second highest matching degree with the query request 312.

It can be understood that the terminal device 110 may determine, according to the acquired query intention, a group of assemblies included in the result presentation template. Referring to an example interface 301 as shown in FIG. 3A, the terminal device 110 determines, according to the query intention of the query request 312 of the question-and-answer category, the question-and-answer result presentation template including the title assembly 411 and/or the content assembly 412. The content assembly 412 may include a text 511 and a video 512. Correspondingly, the terminal device 110 determines the query result corresponding to the query request 312 based on the search engine. Then, the terminal device 110 embeds the content in the query result into the question-and-answer result presentation template including the title assembly 411 and/or the content assembly 412, to present the query result page including the title assembly 411 (e.g., “search highlights”) and/or the content assembly 412 (e.g., text description and/or video A).

Referring to an example interface 302 as shown in FIG. 3A, if the terminal device 110 receives the query request 322 of the content search category (e.g., must-dos for traveling in city A or hot news) based on the input box 311, it determines a result presentation template that matches a query intention associated with the query request 322. Then, the terminal device 110 embeds the query result corresponding to the query request 322 into the result presentation template to form the result query page. The result query page includes a result area 324 for providing a recommended query result 323 from the plurality of query results, i.e., the query result 323 with the highest matching degree with the query request 322 is presented in the result area 324. Next, the terminal device 110 presents, in the result area 325 of the query result page, the query result with the second highest matching degree with the query request 322.

It can be understood that the terminal device 110 may determine, according to the acquired query intention, a group of assemblies included in the result presentation template. Referring back to the example interface 302 as shown in FIG. 3B, the terminal device 110 determines, according to the query intention of the query request 322 of the content search category, a content search result presentation template including the title assembly 411, the categorization assembly 414, and/or the content assembly 412. The categorization assemblies 414 includes a plurality of categories corresponding to the query request 322, such as a scenery spot A and a scenery spot B. The content assembly 412 may include a video A, a video B, etc.

Correspondingly, the terminal device 110 determines the query result corresponding to the query request 322 based on the search engine. Then, the terminal device 110 embeds the content in the query result into the content search result presentation template including the title assembly 411, the categorization assembly 414, and/or the content assembly 412, to present a query result page including “search highlights”, “a scenery spot A, a scenery spot B, etc.” and/or “a video A, a video B, etc.”.

In some embodiments, if the terminal device 120 receives an interaction request associated with the categorization assembly, it presents at least one query result from a group of query results that matches a category indicated by the categorization assembly. Referring to an example interface 302 as shown in FIG. 3B, if the terminal device 120 receives an interaction request for the “scenery spot A” in the recommended query result 323 presented by the categorization assembly, it presents at least one query result that matches the “scenery spot A”.

Referring to an example interface 303 as shown in FIG. 3C, if the terminal device 110 receives the query request 332 of the entity search category (e.g., a song A, a singer XX, a location L, a movie M and a game G) based on the input box 311, it determines a result presentation template that matches the query intention associated with the query request 332. Then, the terminal device 110 embeds the query result corresponding to the query request 332 into the result presentation template to form the result query page. The result query page includes a result area 334 for providing a recommended query result 333 from the plurality of query results, i.e., the query result 333 with the highest matching degree with the query request 332 is presented in the result area 334. Next, the terminal device 110 presents, in a result area 335 of the query result page, the query result with the second highest matching degree with the query request 332.

It can be understood that the terminal device 110 may determine, according to the acquired query intention, a group of assemblies included in the result presentation template. Referring back to the example interface 303 as shown in FIG. 3C, the terminal device 110 determines, according to the query intention of the query request 332 of the entity search category, a content search result presentation template including the title assembly 411, the user assembly 413, and/or the content assembly 412. The user assembly 413 corresponds to information of a user A included by the query request 332, such as an account of the user A and visual information of the user A. The content assembly 412 may include a video A, a video B, etc.

Correspondingly, the terminal device 110 determines the query result corresponding to the query request 332 based on the search engine. Then, the terminal device 110 embeds the content in the query result into the entity search result presentation template including the title assembly 411, the user assembly 413, and/or the content assembly 412, to present a query result page including “singer XX is here”, “account of singer XX, visual information of singer XX, etc.” and/or “video A, video B, etc.”.

In some embodiments, the first display area of the result presentation template is determined based on a display area of the terminal device for presenting the query result, and location parameters and dimension parameters of the group of assemblies are determined based on the first display area. For example, if the display mode of the terminal device 110 is a landscape mode, the display area of the result presentation template adopts landscape display. If the display mode of the terminal device 110 is a portrait mode, the display area of the result presentation template adopts portrait display.

It should be understood that although the specific process of presenting the query result is described above by using the search request as an example of the query request. Alternatively and/or additionally, the query request may further include a prompt word for invoking the capability of the machine learning model to generate an object. For example, the machine learning model may be assigned to generate an image. At this time, a recommended image that best matches the prompt word may be highlighted in the “home page card”, and so on.

By enhancing the prominence of symbols and highlighting authoritative selection of answers, it is possible to reinforce that the content in the home page card is a recommended quality answer. In this way, a developer can directly invoke the predefined assemblies to build the presentation template, which in turn displays the corresponding query results. Furthermore, the card carries the result with the highest matching degree, and the results are clearly distinguished from natural results in the form of color or card, thereby allowing the user to better focus on the result of the quality answer. In summary, a clearer, more harmonious and visually hierarchical query result page can be provided to the user.

### Example Apparatus and Device

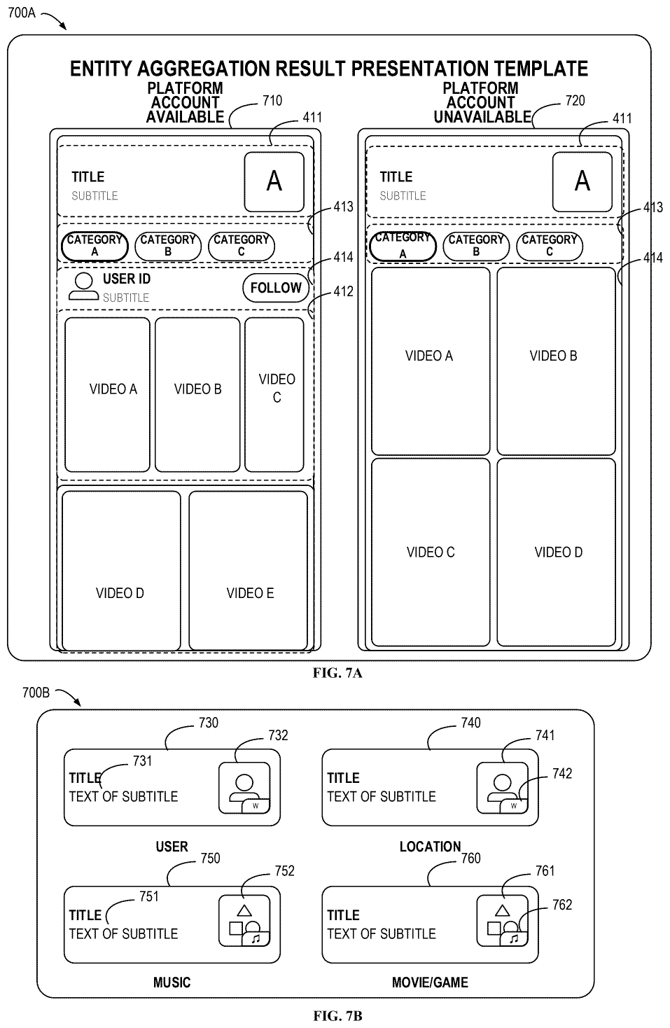

Embodiments of the present disclosure also provide a corresponding apparatus for implementing the above-described method or process. FIG. 8 shows a schematic structural block diagram of an apparatus 800 for presenting a query result according to some embodiments of the present disclosure. The apparatus 800 may be implemented as or included in a terminal device 110. Each module/assembly in the apparatus 800 may be implemented by hardware, software, firmware or any combination thereof.

As shown in FIG. 8, the apparatus 800 includes an intention acquiring module 810 configured to acquire, in response to receiving a query request, a query intention associated with the query request. The apparatus 800 further includes a template determining module 820 configured to determine, from a plurality of result presentation templates, a result presentation template that matches the query intention. The apparatus 800 further includes a page presenting module 830 configured to present, based on the result presentation template, a query result page for the query request, the query result page including a first result area corresponding to the result presentation template, the first result area being intended to provide a recommended first query result from a group of query results for the query request.

In some embodiments, the result presentation template includes a group of assemblies selected according to the query intention, and the group of assemblies includes: a title assembly configured to specify a title of the result presentation template; and a content assembly configured to specify content of the result presentation template, the content including at least one of a text, an image, an audio and a video.

In some embodiments, the group of assemblies further includes at least one of: a user assembly configured to specify information of a user in the result presentation template, the user being a user in an application for executing the method; and a categorization assembly configured to specify a categorization tab in the result presentation template.

In some embodiments, a target assembly from the group of assemblies includes a plurality of configuration parameters, and the plurality of configuration parameters include at least one of: a dimension parameter for setting a dimension of the target assembly; a location parameter for setting a location of the target assembly; and a content parameter for setting a content of the target assembly.

In some embodiments, the template determination module 820 further includes a parameter configuration module configured to: set at least one of the dimension parameter and the location parameter based on a predetermined layout rule; and set the content parameter based on the first query result.

In some embodiments, the parameter configuration module is configured to: extract, from the first query result, data that matches the target assembly for the target assembly from the group of assemblies in the result presentation template; and set a content parameter of the target assembly based on the data.

In some embodiments, for a target assembly from the group of assemblies, a plurality of examples of the target assembly in a plurality of result presentation templates have the same visual attribute.

In some embodiments, at least one query result from the group of query results that matches a category indicated by the categorization assembly is presented in response to receiving an interaction request associated with the categorization assembly.

In some embodiments, a first matching degree between the first query result and the query request is higher than at least one second matching degree between at least one second query result from the group of query results and the query request.

In some embodiments, the query result page further includes a second result area, the second result area is intended to present the at least one second query result from the group of query results, and a location of the at least one second query result in the second result area is determined according to the matching degree between the first query result and the query request.

In some embodiments, a first display area of the result presentation template is determined based on a display area of a terminal device for presenting the query result, and location parameters and dimension parameters of the group of assemblies are determined based on the first display area.

The units and/or modules included in the apparatus 800 may be implemented in various fashions, including software, hardware, firmware, or any combination thereof. In some embodiments, one or more units and/or modules may be implemented using software and/or firmware, for example, machine-executable instructions stored on a storage medium. In addition to or as an alternative to machine-executable instructions, some or all of the units and/or modules in the apparatus 800 may be implemented, at least in part by one or more hardware logic components. By way of example rather limitation, exemplary types of hardware logic components that may be used include a field-programmable gate array (FPGA), an application-specific integrated circuit (ASIC), an application-specific standard product (ASSP), a system-on-chip (SOC), a complex programmable logic device (CPLD), and the like.

It should be understood that one or more of the steps in the above method may be performed by an appropriate electronic device or combination of electronic devices. Such an electronic device or combination of electronic devices may include, for example, the terminal device 110 in FIG. 1.

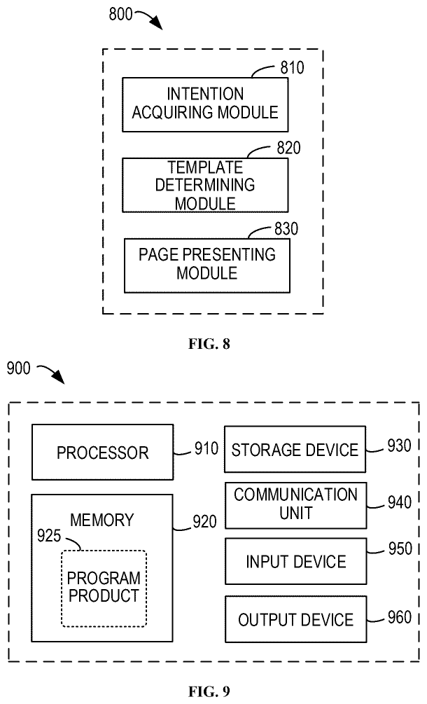

FIG. 9 shows a block diagram of an electronic device 900 in which one or more embodiments of the present disclosure can be implemented. It should be understood that the electronic device 900 shown in FIG. 9 is merely exemplary and should not constitute any limitation on the functions and the scope of the embodiments described herein. The electronic device 900 illustrated in FIG. 9 may be used to implement the terminal device 110 illustrated in FIG. 1.

As shown in FIG. 9, the electronic device 900 is in the form of a general-purpose computing device. Components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor and can execute various processing according to programs stored in the memory 920. In a multiprocessor system, multiple processing units execute computer-executable instructions in parallel to improve a parallel processing capability of the electronic device 900.

The electronic device 900 typically includes multiple computer storage mediums. Such mediums may be any available mediums accessible by the electronic device 900, including but not limited to volatile and nonvolatile mediums, and removable and non-removable mediums. The memory 920 may be a volatile memory (such as a register, a cache and a random access memory (RAM)), a nonvolatile memory (such as a read-only memory (ROM), an electrically erasable programmable read-only memory (EEPROM) and a flash memory) or some combinations thereof. The storage device 930 may be a removable or non-removable medium and may include a machine-readable medium, such as a flash drive, a magnetic disk or any other mediums, which can be used to store information and/or data and may be accessed within the electronic device 900.

The electronic device 900 may further include additional removable/non-removable, volatile/nonvolatile storage mediums. Although not shown in FIG. 9, a disk drive for reading from or writing into a removable and nonvolatile magnetic disk (such as a “floppy disk”) and an optical disk drive for reading from or writing into a removable and nonvolatile optical disk may be provided. In these cases, each drive may be connected to a bus (not shown) by one or more data medium interfaces. The memory 920 may include a computer program product 925 having one or more program modules configured to execute various methods or actions of various embodiments of the present disclosure.

The communication unit 940 realizes communication with other electronic devices through a communication medium. Additionally, functions of the assemblies of the electronic device 900 may be realized in a single computing cluster or a plurality of computing machines, and these computing machines can communicate through communication connections. Therefore, the electronic device 900 can operate in a networked environment by using logical connections with one or more other servers, a network personal computer (PC) or another network node.

The input device 950 may be one or more input devices, such as a mouse, a keyboard and a trackball. The output device 960 may be one or more output devices, such as a display, a speaker and a printer. The electronic device 900 may also communicate with one or more external devices (not shown), such as storage devices and display devices, through the communication unit 940 as needed, communicate with one or more devices that enable users to interact with the electronic device 900, or communicate with any devices (such as network cards and modems) that enable the electronic device 900 to communicate with one or more other computing devices. Such a communication may be executed via an input/output (I/O) interface (not shown).

According to an exemplary embodiment of the present disclosure, a computer-readable storage medium is provided and has a computer-executable instruction stored thereon, wherein the computer-executable instruction is executed by a processor to implement the method described above. According to an exemplary embodiment of the present disclosure, a computer program product is also provided, wherein the computer program product is tangibly stored on a non-transitory computer-readable medium and includes a computer-executable instruction, and the computer-executable instruction is executed by a processor to implement the method described above.

Various aspects of the present disclosure are described herein with reference to the flowcharts and/or block diagrams of the method, the apparatus, the device and the computer program product implemented according to the present disclosure. It should be understood that each block of the flowcharts and/or block diagrams and combinations of various blocks in the flowcharts and/or block diagrams may be realized by computer-readable program instructions.

These computer-readable program instructions may be provided to the processing unit of a general-purpose computer, a special-purpose computer or other programmable data processing apparatus to produce a machine, so that when these instructions are executed by the processing unit of the computer or other programmable data processing apparatus, the apparatus is generated for implementing the functions/actions specified in one or more blocks in the flowcharts and/or block diagrams. These computer-readable program instructions may also be stored in a computer-readable storage medium, and these instructions enable the computer, the programmable data processing apparatus and/or other devices to work in a particular manner, so that the computer-readable medium having the instructions stored includes an article of manufacture including the instructions for implementing various aspects of the functions/actions specified in one or more blocks in the flowcharts and/or block diagrams.

The computer-readable program instructions may be loaded onto the computer, other programmable data processing apparatuses, or other devices, such that a series of operation steps are executed on the computer, other programmable data processing apparatuses, or other devices to produce a computer-implemented process. Therefore, the instructions executed on the computer, other programmable data processing apparatuses, or other devices implement the functions/actions specified in one or more blocks in the flowcharts and/or block diagrams.

The flowcharts and block diagrams in the figures show possibly realized architectures, functions and operations of systems, methods and computer program products according to multiple implementations of the present disclosure. In this regard, each block in the flowcharts or block diagrams may represent a module, a program segment or a part of instruction, and the module, the program segment or the part of instruction contains one or more executable instructions for realizing specified logical functions. In some alternative implementations, the functions noted in the blocks may also occur in a different order than those noted in the figures. For example, two consecutive blocks may be actually executed substantially in parallel, and sometimes they may be executed in a reverse order, depending on the functions involved. It should also be noted that each block in the block diagrams and/or flowcharts and combinations of the blocks in the block diagrams and/or flowcharts may be implemented by using a dedicated hardware-based system executing specified functions or actions, or may be implemented by a combination of dedicated hardware and computer instructions.

Various implementations of the present disclosure have been described above, and the above descriptions are exemplary, are not exhaustive, and are not limited to the disclosed various implementations. Many modifications and changes will be obvious to those ordinary skilled in the art without departing from the scope and spirit of the described various implementations. The terminology used herein is chosen to best explain principles and practical application of various implementations or improvement to technologies in the market, or to enable other ordinary skilled in the art to understand various embodiments disclosed herein.

What is claimed is:

1. A method for presenting a query result, comprising:
in response to receiving a query request, acquiring a query intention associated with the query request;
determining, from a plurality of result presentation templates, a result presentation template that matches the query intention; and
presenting, based on the result presentation template, a query result page for the query request, the query result page comprising a first result area corresponding to the result presentation template, the first result area being configured to provide a recommended first query result from a group of query results for the query request.

2. The method of claim 1, wherein the result presentation template comprises a group of assemblies selected according to the query intention, and the group of assemblies comprise:
a title assembly configured specify a title of the result presentation template; and
a content assembly configured to specify content of the result presentation template, the content comprising at least one of: a text, an image, an audio, or a video.

3. The method of claim 2, wherein the group of assemblies further comprises at least one of:
a user assembly configured to specify information of a user in the result presentation template, the user being a user in an application for executing the method; or
a categorization assembly configured to specify a categorization tag in the result presentation template.

4. The method of claim 2, wherein a target assembly in the group of assemblies comprises a plurality of configuration parameters, and the plurality of configuration parameters comprises at least one of:
a dimension parameter for configuring a dimension of the target assembly;
a location parameter for configuring a location of the target assembly; or
a content parameter for configuring content of the target assembly.

5. The method of claim 4, further comprising:
configuring, based on a predetermined layout rule, at least one of: the dimension parameter and the location parameter; and
configuring the content parameter based on the first query result.

6. The method of claim 5, wherein configuring the content parameter comprises:
extracting, from the first query result, data that matches the target assembly, for the target assembly among the group of assemblies in the result presentation template; and
configuring the content parameter of the target assembly based on the data.

7. The method of claim 2, wherein for a target assembly among the group of assemblies, a plurality of instances of the target assembly in a plurality of result presentation templates has a same visual attribute.

8. The method of claim 3, further comprising:
in response to receiving an interaction request associated with the categorization assembly, presenting at least one query result from the group of query results that matches a category indicated by the categorization assembly.

9. The method of claim 1, wherein a first matching degree between the first query result and the query request is higher than at least one second matching degree between at least one second query result from the group of query results and the query request.

10. The method of claim 9, wherein the query result page further comprises a second result area, the second result area being configured to present the at least one second query result from the group of query results, and a location of the at least one second query result in the second result area is determined according to the matching degree between the first query result and the query request.

11. The method of claim 1, wherein a first display area of the result presentation template is determined based on a display area of a terminal device for presenting the query result, and location parameters and dimension parameters of the group of assemblies are determined based on the first display area.

12. An electronic device, comprising:
at least one processor; and
at least one memory coupled to the at least one processor and storing instructions executable by the at least one processor, the instructions, when executed by the at least one processor, causes the electronic device to perform acts comprising:
in response to receiving a query request, acquiring a query intention associated with the query request;
determining, from a plurality of result presentation templates, a result presentation template that matches the query intention; and
presenting, based on the result presentation template, a query result page for the query request, the query result page comprising a first result area corresponding to the result presentation template, the first result area being configured to provide a recommended first query result from a group of query results for the query request.

13. The electronic device of claim 12, wherein the result presentation template comprises a group of assemblies selected according to the query intention, and the group of assemblies comprise:
a title assembly configured specify a title of the result presentation template; and
a content assembly configured to specify content of the result presentation template, the content comprising at least one of: a text, an image, an audio, or a video.

14. The electronic device of claim 13, wherein the group of assemblies further comprises at least one of:
a user assembly configured to specify information of a user in the result presentation template, the user being a user in an application for executing the method; or
a categorization assembly configured to specify a categorization tag in the result presentation template.

15. The electronic device of claim 13, wherein a target assembly in the group of assemblies comprises a plurality of configuration parameters, and the plurality of configuration parameters comprises at least one of:
a dimension parameter for configuring a dimension of the target assembly;
a location parameter for configuring a location of the target assembly; or
a content parameter for configuring content of the target assembly.

16. The electronic device of claim 15, wherein the acts further comprise:
configuring, based on a predetermined layout rule, at least one of: the dimension parameter and the location parameter; and
configuring the content parameter based on the first query result.

17. The electronic device of claim 16, wherein configuring the content parameter comprises:
extracting, from the first query result, data that matches the target assembly, for the target assembly among the group of assemblies in the result presentation template; and
configuring the content parameter of the target assembly based on the data.

18. The electronic device of claim 13, wherein for a target assembly among the group of assemblies, a plurality of instances of the target assembly in a plurality of result presentation templates has a same visual attribute.

19. The electronic device of claim 13, wherein the acts further comprise:
in response to receiving an interaction request associated with the categorization assembly, presenting at least one query result from the group of query results that matches a category indicated by the categorization assembly.

20. A non-transitory computer-readable storage medium comprising computer program stored thereon, the computer program, when executable by a processor, causing the processor to implement a method comprising:
in response to receiving a query request, acquiring a query intention associated with the query request;
determining, from a plurality of result presentation templates, a result presentation template that matches the query intention; and
presenting, based on the result presentation template, a query result page for the query request, the query result page comprising a first result area corresponding to the result presentation template, the first result area being configured to provide a recommended first query result from a group of query results for the query request.
